(19) United States
(12) Patent Application Publication
(10) Pub. No.: US 2024/0369152 A1
(43) Pub. Date: Nov. 7, 2024

(54) SOLENOID VALVE AND METHOD FOR OPERATING A SOLENOID VALVE

(71) Applicant: Festo SE & Co. KG, Esslingen (DE)

(72) Inventors: Andreas BÜHLER, Stuttgart (DE); Tobias WATZER, Deizisau (DE); Jens ENGELHARDT, Esslingen (DE)

(21) Appl. No.: 18/653,333

(22) Filed: May 2, 2024

(30) Foreign Application Priority Data
May 5, 2023 (DE) 10 2023 111 712.2

(51) Int. Cl. F16K 31/06

(52) U.S. Cl. CPC F16K 31/0675

(57) ABSTRACT

A solenoid valve, including a valve housing with a fluid channel and a valve member located moveably in the fluid channel between a first and a second functional position and a solenoid coil to move the valve member. A valve control provides electrical energy to the solenoid coil and includes a timer, which timer is activated by a first movement signal to the valve control or which timer is activated upon arrival of the valve member in the first functional position. The timer has a first state before a predefined time span has elapsed and the timer has a second state after the predefined time span has elapsed and the valve control interrogates the respective state and provides a first quantity of electrical energy during the first state and provides a second quantity of electrical energy, which is greater than the first quantity, during the second state.

This application claims priority to German Patent Application No. 10 2023 111 712.2 filed May 5, 2023, which is incorporated by reference.

### SUMMARY OF THE INVENTION

The invention relates to a solenoid valve, the solenoid valve comprising a valve housing, in which a fluid channel with a valve opening is formed, the solenoid valve further comprising a valve member, which valve member is moveably received in the fluid channel between a first functional position and a second functional position, the solenoid valve further comprising a solenoid coil to provide magnetic forces to the valve member, the solenoid valve further comprising a valve control to provide electrical energy to the solenoid coil. The invention also relates to a method for operating a solenoid valve.

Such a solenoid valve is used, for example, for controlling a fluid flow, in particular a compressed air flow, in the field of industrial automation or laboratory technology. For this purpose, the solenoid valve has a valve housing through which a fluid channel passes, which extends between at least one input connection and at least one output connection, whereby a fluid line can be connected to the input connection and wherein a fluid line can be connected to the output connection, which fluid line is in particular in the form of a tube or hose. A valve opening, also named a valve seat, is formed in the fluid channel, which can be optionally blocked or released by a valve member, which is moveably accommodated in the fluid channel. The valve member is designed in such a way that it can be moved between a first functional position and a second functional position, wherein the valve member seals the valve opening in the first functional position or in the second functional position. The movement of the valve member is dependent from a magnetic flux that can be provided by a solenoid coil arranged in or on the valve housing. Furthermore, the solenoid valve comprises a valve control, which can be located remote from the valve housing or in the valve housing, and which is designed to provide electrical energy to the solenoid coil. It is assumed that the valve control is connected via an electrical control line to a higher-level control device that does not belong to the solenoid valve, such as a programmable logic controller or a control device of a valve terminal. The higher-level control device is designed to provide electrical movement signals to the valve control, which valve control is also connected to an electrical source, in particular a voltage source or current source, and which, when a corresponding movement signal arrives, provides or stops the provision of electrical energy to the solenoid coil.

DE 10 129 153 A1 discloses an electromagnetic valve with a valve coil arrangement and means for reducing the electric current provided to the solenoid coil from a higher pull-in current to a lower holding current after switching the valve, wherein sensor means are provided for detecting a parameter which changes when the valve is switched and switching means are used to switch to the lower holding current as a function of this change.

U.S. Pat. No. 5,377,068 A1 discloses a control system for an electromagnetic device to prevent overheating of the coils to permit optimizing design parameters without the need for excessive safety factors. A pull coil circuit feeds a high current to pull windings for a preset time interval after receipt of an initiating voltage. A hold coil circuit feeds a holding current to holding windings with a reduced flux after receipt of an initiating voltage only if it exceeds a preset voltage threshold. The hold current is cut off when the initiating voltage falls below a preset threshold. The pull coil circuit is rendered inoperative for a preset time interval after current is discontinued to ensure adequate cooling between operations.

The task of the invention is to provide a solenoid valve and a method for operating a solenoid valve with which low heating of the solenoid valve can be realized even at high switching frequencies for the solenoid valve.

This task is solved for a solenoid valve of the type mentioned above
wherein the valve control comprises a timer, which timer is activated upon a provision of a first movement signal to the valve control, wherein the first movement signal indicates a transfer of the valve member from the first functional position to the second functional position or which timer is activated upon arrival of the valve member in the first functional position, wherein the timer has a first state before a predefined time span has elapsed and wherein the timer has a second state after the predefined time span has elapsed and the valve control interrogates the state of the timer and provides a first quantity of electrical energy to the solenoid coil during the first state and provides a second quantity of electrical energy to the solenoid coil during the second state wherein the first quantity of electrical energy is smaller than the second quantity of electrical energy. In particular, the electrical current provided from the valve control to the solenoid coil is lower in the first state compared with the second state.

The concept of the invention is to take into account a dwell time or resting time of the valve member in the first functional position and/or in the second functional position for providing a specific amount of electrical energy to the solenoid coil dependent from the dwell time. This dwell time has an influence on the amount of energy required to transfer the valve member from the respective functional position to the respective other functional position. This is due to the fact that the valve member in the respective functional position, in particular in the closed position for the solenoid valve, in which the valve member seals the valve opening and therefore blocks a fluid flow in the fluid channel, builds up increasing adhesive forces as a function of time, which adhesive forces must be taken into account for a reliable transfer of the valve member from this functional position to the respective other functional position when providing electrical energy to the solenoid coil.

As an example, it can be assumed that a minimum amount of energy is required immediately after reaching the respective functional position in order to transfer the valve member back to the other functional position. If the arrival of the valve member in the respective functional position is followed by a shorter dwell time, which can be in the range of a few seconds, a somewhat higher amount of energy is already required, as the valve member exhibits increased movement friction, for example due to adhesion effects. If the arrival of the valve member in the respective functional position is followed by a longer dwell time, which can be in the range of minutes or hours, the amount of energy required to move the valve member again increases further. The individual changes in the amount of energy required to move the valve member from one functional position to the other depend on a variety of factors, in particular the structure of the solenoid valve and the state of wear of the solenoid valve.

The related electrical energy quantities required to transfer the valve member from one functional position to the other functional position could in principle be stored in the valve control in the form of empirically determined data, in particular in the form of a mathematical equation, so that an individual amount of energy could be assigned to each dwell time determined by the timer. In practice, it has already proven to be advantageous to provide two different amounts of energy, whereby the first amount of energy is used for a shorter dwell time of the valve member in the respective functional position, while the second, larger amount of energy is used for a longer dwell time of the valve member in the respective functional position.

In order to enable the valve control to decide whether the first or the second amount of energy should be used to actuate the solenoid coil, the timer is assigned to the valve control. This timer can be designed in the form of an electric or electronic stopwatch, in particular in the form of a software-based counter and is designed to determine a period of time from a predetermined start time. This predetermined start time may start on a provision of a first movement signal to the valve control, wherein the first movement signal is directed to a transfer of the valve member from the first functional position to the second functional position. In addition, or alternatively the predetermined start time may start upon an arrival of the valve member in the first functional position. Furthermore, the timer is designed to carry out a change of state after a predetermined period of time has elapsed.

A start time for the timer can be determined, for example, by the valve member reaching the first functional position. An additional or alternative determination of a start time for the timer can be made by activating the timer when a movement signal is provided to the valve control, whereby this movement signal is provided by a higher-level control that is electrically connected to the valve control and is aimed at transferring the valve member between the one functional position and the other functional position.

The timer can optionally be realized as a discrete electronic component or as an integral part of the valve control, which is usually formed by a microprocessor or microcontroller with corresponding electrical peripherals. Preferably the timer is a part of a computer program that is processed by the valve control, whereby a program part of this computer program designed to receive and process motion signals provides a start signal to the timer at the respective start time. When the start signal arrives, the process of determining the time interval takes place in the timer, if necessary, after resetting a time counter of the timer. It is intended that the timer assumes a first state when the start signal arrives, which can, for example, be represented as a logical high level within the timer. It is also provided that the timer assumes a second state after the time interval has elapsed, which can be represented, for example, as a logic low level within the timer.

When a first movement signal arrives, which is aimed at transferring the valve member from the second functional position, which is in particular an opening position for the solenoid valve, to the first functional position, which is in particular a closing position for the solenoid valve, the timer is queried by the valve control. For example, the computer program running in the microprocessor of the valve control, which releases electrical energy to the solenoid coil as a function of the movement signal, can be used to query the timer running as a sub-process in this computer program so that the required amount of energy can be provided as a function of the state of the timer. For this purpose, it is provided in particular that the valve control has an electrical output stage which is electrically connected to the microprocessor and which, as a function of an actuation signal which can be output by the microprocessor, provides the electrical energy to the solenoid coil which is provided by an electrical source which is formed in particular outside the solenoid valve.

As an example, it is provided that the first amount of electrical energy is less than 70 percent, preferably less than 60 percent, in particular less than 50 percent of the second amount of electrical energy.

Advantageous further embodiments of the invention are the subject of the subclaims.

It is expedient if the valve opening and the valve member are formed as a pairing from the group: spool channel and valve spool, valve seat and valve seat sealing element, valve opening and valve diaphragm. In principle, the solenoid valve can be designed in a wide variety of embodiments in order to influence a fluid flow through the fluid channel as a function of a functional position of the valve member, in particular to block and release the fluid channel. In the field of automation technology, i.e. the fluid supply of machine components, in particular the fluid supply of processing machines or handling equipment, compressed air is often used. Since a significant cooling effect for the solenoid valve can neither be assumed for the case of a release of the fluid channel, in which a fluid flow takes place through the fluid channel, nor for the case of a blockage of the fluid channel, in which the fluid in the fluid channel is at rest due to the blockage by the valve member, the invention is used in particular in spool valves, in poppet valves and in diaphragm valves.

In a spool valve, it is provided that a spool channel designed as a bore, in particular as a circular cylindrical bore, is released and blocked by a valve spool which can be displaced linearly along a bore axis and which can in particular be a rod-shaped valve spool with at least one radial seal, in particular an O-ring. As an example, it is provided that the valve spool is optionally accommodated in the spool channel in a sealing manner, which produces the blocking effect for the fluid channel, or is arranged by a linear displacement movement in a section of the fluid channel adjacent to the spool channel, which has a larger cross-section than the spool channel to allow a fluid flow in the fluid channel.

In a poppet valve, the valve member is mounted for linear movement transversely to an extension axis of a first fluid channel section and can optionally block or unblock an orifice, referred to as a valve seat or valve opening, of a second fluid channel section which is also aligned transversely to the extension axis of the first fluid channel section. In this case, it is preferably provided that the second fluid channel section has a second cross-section in the region of the orifice opening which is smaller than a first cross-section of the first fluid channel section and herewith forms the valve seat. Furthermore, it is provided that the valve member is directly surrounded by the fluid flowing through the fluid channel.

A diaphragm valve can be regarded as a variant of the poppet valve, in which the valve member is separated from the fluid channel by a flexible, in particular elastic, diaphragm and a movement of the valve member leads to a deformation of the diaphragm in order to thereby optionally block or release the valve seat.

In a further embodiment of the invention, it is provided that the valve member is designed to block the valve opening in the first functional position and to release the valve opening in the second functional position.

In a further embodiment of the invention, it is provided that the valve control is designed to provide a holding current to the solenoid coil when the valve member reaches the second functional position in order to hold the valve member in the second functional position, wherein this holding current is lower than a pull-in-current which is required to move the valve member from the first functional position to the second functional position. In particular the holding current is provided until a second movement signal arrives, which is directed towards transferring the valve member from the second functional position to the first functional position and which may effect the switching off of the valve current. The purpose of reducing the holding current in this way is to minimize the energy consumption of the solenoid valve and the associated heating of the solenoid valve, when the valve member is in the second functional position. It should be taken into account here that static holding of the respective functional position of the valve member requires considerably less energy than moving the valve member between the two functional positions. Accordingly, the valve control is set up in such a way that, after reaching the second functional position, it permanently provides a holding current to the solenoid coil, which is dimensioned in such a way that the valve member is held in the second functional position. In particular, return forces of a spring device, which can be provided to transfer the valve member from the second functional position to the first functional position and/or return forces of other functional elements such as a valve diaphragm, which act on the valve member, must be taken into account. As an example, it is provided that the holding current is significantly smaller than a movement current that is provided to the solenoid coil for transferring the valve member from the first functional position to the second functional position. In particular, the holding current is less than 70 percent, preferably less than 60 percent, particularly preferably less than 50 percent of the movement current.

It is preferable that the first amount of electrical energy and the second amount of electrical energy differ from each other by at least one variable from the group: coil voltage, coil current, provision time. The electrical coil voltage, which is provided by a voltage source to the valve control and from there to the solenoid coil, can be influenced either by the electrical output stage of the valve control or by a specific control of the electrical voltage source by the valve control and results in a coil current depending on the electrical properties and the induction properties of the solenoid coil.

When varying the coil current to be provided to the solenoid coil, it is assumed that the valve control is connected to a current source, whereby the valve control is designed to influence the coil current provided by the current source by means of a current signal provided to the current source.

In addition, or as an alternative to influencing the coil voltage or the coil current, the valve control can also be designed to influence a supply duration for the coil voltage or the coil current in order to thereby vary the amount of electrical energy supplied to the solenoid coil. The supply duration is the period of time within which the first quantity of electrical energy is supplied.

It is useful if the valve control is designed to detect a coil current through the solenoid coil and to determine the arrival of the valve member in the first and/or second functional position on the basis of the detected coil current. This detection is based on the consideration that the coil current has a characteristic curve when the valve member is transferred from one functional position to the other functional position, also taking into account the variation between the first amount of energy and the second amount of energy, from which, among other things, the information that the valve member has reached the other functional position starting from one functional position can be determined. With such an analysis of the current curve for the coil current of the solenoid coil, the start time for the timer can be determined on the one hand and, on the other hand, a holding current reduction for the solenoid coil can be activated additionally or alternatively.

The task of the invention is also solved by a method for operating a solenoid valve, in which a valve member is moved between a first functional position and a second functional position by a magnetic field of a solenoid coil, which solenoid coil is supplied with a coil current by a valve control as a function of a movement signal. The method comprises the following steps: Provision of a first movement signal to the valve control in order to move the valve member from the first functional position to the second functional position, provision of a second movement signal to the valve control in order to move the valve member from the second functional position to the first functional position, determination of a time span, which begins with an arrival of the valve member in the first functional position or with a provision of the second movement signal to the valve control, wherein for a subsequent transfer of the valve member from the first functional position to the second functional position, an amount of electrical energy is supplied by the valve control to the solenoid coil which depends on the determined time interval and which lies within a predetermined energy interval.

In the method according to the invention, the time interval to be determined by the timer is measured as a first variant from the point in time at which the valve member has reached the first functional position starting from the second functional position or has reached the first functional position at least with a high probability. A sensor-based determination of the position of the valve member and thus an actual position observation for the valve member is provided as an example.

As a second variant, which can be provided in addition to or as an alternative to the first variant, the period of time to be determined by the timer is measured from the time at which the valve control receives a second movement signal which is directed towards a transfer of the valve member from the second functional position to the first functional position.

Afterwards, when a further first movement signal arrives in the valve control, which is directed towards the transfer of the valve member from the first functional position to the second functional position, the valve control provides a quantity of electrical energy to the solenoid coil, which is dependent on the time interval that the timer has determined. As an example, it is intended that the amount of electrical energy increases with an increasing amount of time in order to reliably overcome an, not necessarily linearly, increasing resistance to movement for the valve member over the dwell time of the valve member in the first functional position. This does not necessarily require a proportional relationship between the dwell time and the amount of electrical energy. Rather, a minimum amount of energy is always required to transfer the valve member from the first functional position to the second functional position, depending on the type of solenoid valve and optionally of the characteristics of return device, in particular a return spring. Furthermore, it can be assumed that even if the valve member remains in the first functional position for a very long time, a maximum amount of electrical energy will not be exceeded or that if the valve member fails to move when the maximum amount of electrical energy is provided, the solenoid valve will malfunction.

In a further development of the method, it is provided that the valve control provides a first amount of electrical energy to the solenoid coil when a further first movement signal is provided to the valve control within predefined time interval, in particular within a predetermined maximum value for the time span, and that the valve control provides a second amount of electrical energy to the solenoid coil when a further first movement signal is provided to the valve control after the predefined timer interval, in particular outside the predetermined maximum value for the time span, wherein the first amount of electrical energy is smaller than the second amount of electrical energy. Preferably, the first amount of electrical energy is selected such that it is at most 70 percent, preferably at most 60 percent, in particular at most 50 percent of the second amount of electrical energy.

In a further embodiment of the method, it is provided that the valve control detects a coil current through the solenoid coil and uses the detected coil current to determine whether the valve member has reached the first and/or second functional position. This utilizes the effect that, due to the inductivity of the solenoid coil, an induction current induced in the solenoid coil occurs in the opposite direction to the coil current provided by the valve control, resulting in a characteristic current curve for determining the solenoid coil. Furthermore, the inductance of the solenoid coil changes due to the movement of the valve member between the second functional position and the first functional position, which has an additional influence on the course of the coil current, which inductance can be detected by sensing the coil current with a suitable current measuring device. The detected coil current can then be used to draw conclusions about the position of the valve member, so that the start signal can be output to the timer when the valve member reaches the first functional position, for example.

Preferably, the valve control provides a holding current to the solenoid coil when the valve member reaches the second functional position until the second movement signal arrives, which is directed towards transferring the valve member from the second functional position to the first functional position, in order to hold the valve member in the second functional position.

### BRIEF DESCRIPTION OF THE DRAWINGS

Advantageous embodiments of the invention are shown in the drawing. It shows:

FIG. 1 is a purely schematic representation of a first embodiment of a solenoid valve, which is designed as a seat valve,

FIG. 2 is a purely schematic representation of a second embodiment of a solenoid valve, which is designed as a diaphragm valve,

FIG. 3 is a purely schematic representation of a third embodiment of a solenoid valve designed as a slide valve, and

FIG. 4 is a purely schematic representation of a current circuit for supplying a solenoid coil of a solenoid valve.

### DETAILED DESCRIPTION OF THE INVENTION

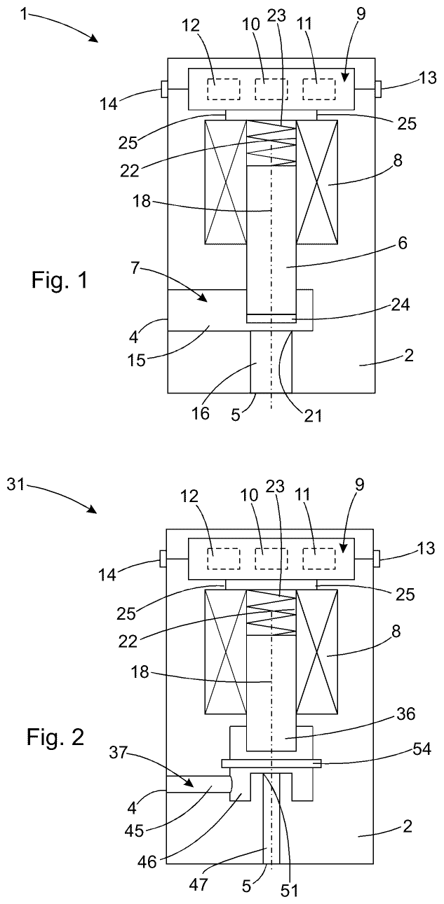

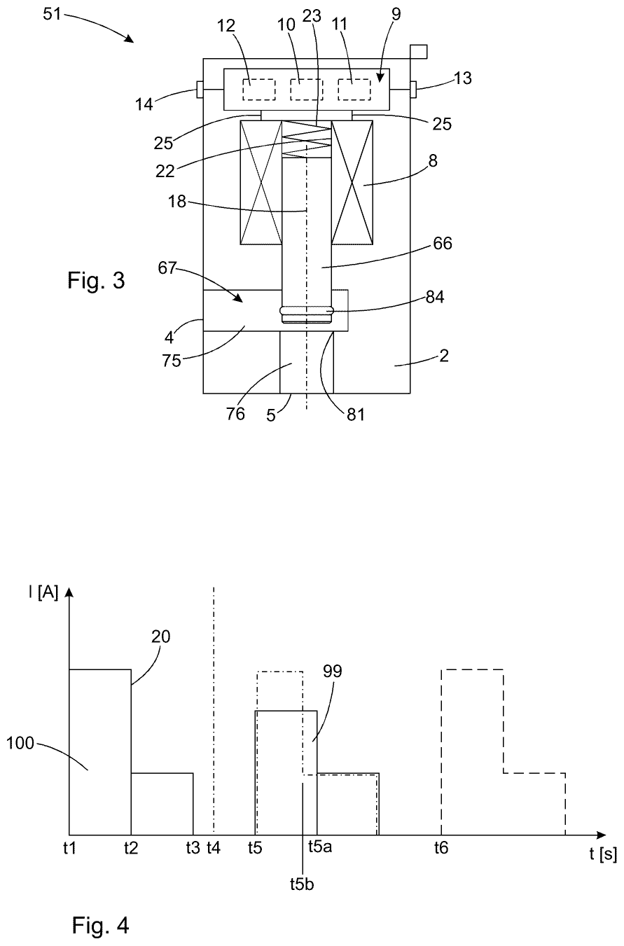

The embodiments of solenoid valves 1, 31, 61 shown strictly schematically in FIGS. 1 to 3 differ in the respective design of the valve member 6, 36, 66 and the fluid channel 7, 37, 67, while the other components such as the solenoid coil 8 and the valve control 9 are each designed identically and are therefore only described in more detail in connection with FIG. 1, while a description of these components in connection with FIGS. 2 and 3 is omitted in order to avoid repetition.

The solenoid valve 1 shown in FIG. 1 is designed as a seat valve, in which the fluid channel 7 extends between a first fluid connection 4 and a second fluid connection 5 in a valve housing 2. The fluid channel 7 is subdivided into a first fluid channel section 15 and a second fluid channel section 16, which are formed purely by way of example as bores with bore axes that are aligned transversely to one another and are not shown. A valve seat 21 is formed at a transition between the first fluid channel section 15 and the second fluid channel section 16, which can also be regarded as an orifice of the second fluid channel section 16 with respect to the first fluid channel section 15.

Furthermore, the valve housing 2 accommodates a valve member 6, which moves linearly along an axis of movement 18, the solenoid coil 8 and the valve control 9, wherein the valve member 6 projects partially into a coil recess 22 of the solenoid coil 8 and wherein a return spring 23, which is designed to provide return forces along the axis of movement 18, is arranged at an end region of the valve member 6 facing away from the fluid channel 7. By way of example only, the valve member 6 is partially manufactured from a ferromagnetic material and can be moved linearly along the axis of movement 18 against a return force provided by the return spring 23 when a coil current is provided to the solenoid coil 8. As shown in FIG. 1, this movement takes place in an upward vertical direction and results in an increase in the distance between the valve member 6 and the valve seat. As a result, a sealing element 24 arranged on the end face of the valve member 6, which is made of a rubber-elastic material, is lifted off the valve seat 21 so that a fluidic communicating connection between the first fluid channel section 15 with the associated first fluid connection 4 and the second fluid channel section 16 with the associated second fluid connection 5 is released. By way of example, a functional position of the valve member 6, in which the sealing element 24 is in sealing contact with the valve seat 21, is referred to as the first functional position. Furthermore, by way of example only, the positioning of the valve member 6 shown in FIG. 1 is referred to as the second functional position.

For the provision of electrical energy to the magnet coil 8, the valve control 9 comprises a microprocessor 10, a timer 11 and an electrical output stage 12. Furthermore, the valve control 9 is assigned a signal input 13, which is designed for coupling a higher-level control unit, and a current input 14, which is designed for connection to a current source.

During operation of the solenoid valve 1, the microprocessor 10 is permanently supplied with power from the power source and is designed to execute a computer program that is stored in a memory area of the microprocessor 10. As an example, it is provided that the computer program is designed to provide an electric current to the solenoid coil 8 when a movement signal arrives, which can be provided at the signal input 13 by the higher-level controller. For this purpose, the microprocessor 10 provides a control signal to the electrical output stage 12 so that it can provide the coil current for the solenoid coil 8 via connecting lines 25, which are formed between the valve control 9 and the solenoid coil 8.

The timer 11, which is also associated with the valve control 9, is designed to first reset a stored time span when a start signal provided by the microprocessor 10 is made available, in order to then determine a time span and compare the determined time span with a predetermined time span. Furthermore, the timer 11 is designed to assume a first state during a phase in which the determined time span is not greater than the predetermined time span and to assume a second state during a phase in which the determined time span is greater than the predetermined time span. Optionally, it can be provided that the timer 11 actively provides this state to the microprocessor 10 or that this state is read out from the timer 11 by the microprocessor 10.

The computer program running in the microprocessor 10 is designed in such a way that when a movement signal arrives, in particular a first movement signal directed towards the transfer of the valve member 6 from the first functional position to the second functional position as shown in FIG. 1, a query of the state of the timer 11 is carried out and, depending on the state of the timer 11, either a first amount of electrical energy is provided to the solenoid coil 8 or a second amount of electrical energy is provided to the solenoid coil 8. The first amount of electrical energy and the second amount of electrical energy differ in that the second amount of electrical energy is greater than the first amount of electrical energy. In this way, it can be taken into account that the valve member 6 with the sealing element 24 experiences at least a certain time-dependent adhesion, which increases with increasing dwell time, during a longer dwell time in the first functional position, in which the sealing element 24 is in sealing contact with the valve seat 21. Therefore, for the transfer to the second functional position, as shown in FIG. 1, a greater amount of electrical energy is required than is the case when the valve member 6 is to be returned to the second functional position immediately after reaching the first functional position.

Furthermore, the computer program running in the microprocessor 10 can also reduce the holding current. For this purpose, it may be provided that the microprocessor 10, at a time at which it is known or can be assumed that the valve member 6 has reached the second functional position, in particular using the timer 11, reduces the coil current which is released by the microprocessor 10 using the electrical output stage 12 in order to hold the valve member 6 in the second functional position against the preload of the return spring 23.

The second embodiment of a solenoid valve 31 shown in FIG. 2 differs from the first embodiment of the solenoid valve 1 in that instead of the sealing element 24 arranged on the end face of the valve member 6, a sealing diaphragm 54 clamped in the valve housing 32 is provided, which ensures fluidic separation between the fluid channel 37 and the valve member 36. Therefore, the solenoid valve 31 is a diaphragm valve. In the embodiment shown in FIG. 2, the fluid channel 37 has a first fluid channel section 45 formed as a bore, a second fluid channel section 46 formed at least in part as an annular channel and a third fluid channel section 47 formed as a bore, the valve seat 51 being formed at the transition between the second fluid channel section 46 and the third fluid channel section 47.

The third embodiment of a solenoid valve 61 shown in FIG. 3 is substantially similar to the first embodiment of the solenoid valve 1. The difference between the solenoid valve 61 and the solenoid valve 1 is that the valve member 66 is provided with a sealing ring 84 serving as a radial seal, which is sealingly received in the second fluid channel section 76 during a linear displacement of the valve member 66 from the second functional position, as shown in FIG. 3, into a first functional position not shown. Accordingly, the solenoid valve 61 is designed as a slide valve or spool valve, whereby the valve member 66 can be referred to as a valve slide and the second fluid channel section can be referred to as a slide channel.

The illustration in FIG. 4 shows purely schematically a course of a coil current 20 provided to the solenoid coil 8 of the solenoid valve 1 for different dwell times of the valve member 6 in the first functional position. As can be seen from FIG. 4, at a point in time t1, which corresponds for example to an initial start-up of the solenoid valve 1, a first provision of coil current to the solenoid coil 8 takes place. With this provision of coil current 20, it is assumed that the valve member 6 has remained in the first functional position for a longer period of time, so that an amount of electrical energy is provided to the solenoid coil, which is referred to as the second amount of energy 100 and which has an amount corresponding to the area under the coil current 20 up to time t2. At time t2, the microprocessor 10 reduces the coil current 20 to a lower level, which is also referred to as the holding current level, since it can be assumed that the valve member 6 has reached the second functional position at this time, as shown in FIG. 1.

At a point in time t3, the valve control 9 receives a second movement signal, which is aimed at transferring the valve member 6 from the second functional position to the first functional position. By way of example only, it is assumed that this movement of the valve member 6 is caused just, in particular exclusively, by switching off the coil current 20. When the first functional position is reached at a time t4, which can be realized, for example, by monitoring the current induced in the solenoid coil by the movement of the valve member 6 by a current sensor assigned to the valve control 9 and not shown, the microprocessor 10 sends a start signal to the timer 11. The timer 11 then resets a stored time value and subsequently and immediately starts a timing process. Furthermore, the timer 11 repeatedly compares the time elapsed after the reset with a predetermined time span stored in the timer, in particular a freely programmable time span. If the time elapsed after the reset is less than the stored time span, the timer 11 sets a memory cell that can be read out by the microprocessor 11, for example to a logic high level. If the time elapsed after the reset is greater than the stored time span, the timer 11 sets the memory cell that can be read out by the microprocessor 11, for example to a logic low level.

When a further first movement signal arrives, the memory cell of the timer 11 is read out by the microprocessor 10 and the value stored in the memory cell is processed in the computer program. For example, at time t5, when a further first movement signal arrives at the valve control 9, the time elapsed after the reset is less than the stored time span, so that a logical high level is stored in the memory cell. In this case, the computer program of the microprocessor 10 provides a first amount of electrical energy 99 to the solenoid coil 8, which is less than the second amount of electrical energy 100, by controlling the electrical output stage 12 accordingly. This results in the coil current 20 shown with a solid line from the time t5, which is characterized by a lower current intensity compared to the coil current between the times t1 and t2, while the time interval until the switchover to the lower holding current level, which takes place at the time t5a, corresponds to the time difference between the times t1 and t2. In an alternative procedure, the first amount of electrical energy 99 is realized by supplying the same amount of current to the solenoid coil 8 from time t5 as from time t1, but the time span for the coil current, which is provided from time t5, is less than the time difference between times t1 and t2. In FIG. 4, this procedure is symbolized by a coil current shown as a dotted line. In this procedure, the switchover to the lower holding current level at time t5b is purely exemplary.

If a further first movement signal only arrives at the valve control 9 at a time t6, the time elapsed after the reset is greater than the stored time span, so that a logical low level is stored in the memory cell. In this case, the computer program of the microprocessor 10 provides the second electrical energy quantity to the solenoid coil 8, which is greater than the first electrical energy quantity 8, by corresponding control of the electrical output stage 12. This results in the coil current 20 shown with a dashed line from the time t6.

1. A solenoid valve, comprising a valve housing, in which a fluid channel with a valve opening is formed, further comprising a valve member, which valve member is moveably received in the fluid channel between a first functional position and a second functional position, further comprising a solenoid coil to provide magnetic forces to the valve member, further comprising a valve control to provide electrical energy to the solenoid coil, wherein the valve control comprises a timer, which timer is activated upon a provision of a first movement signal to the valve control, wherein the first movement signal indicates a transfer of the valve member from the first functional position into the second functional position or which timer is activated upon arrival of the valve member in the first functional position, wherein the timer has a first state before a predefined time span has elapsed and wherein the timer has a second state after the predefined time span has elapsed and the valve control interrogates the state of the timer and provides a first quantity of electrical energy to the solenoid coil during the first state and provides a second quantity of electrical energy to the solenoid coil during the second state wherein the first quantity of electrical energy is smaller than the second quantity of electrical energy.

2. The solenoid valve according to claim 1, wherein the valve opening and the valve member are formed as a pairing from the group: spool channel and valve spool, valve seat and valve seat sealing element, valve opening and valve diaphragm.

3. The solenoid valve according to claim 1, wherein the valve member blocks the valve opening in the first functional position and releases the valve opening in the second functional position.

4. The solenoid valve according to claim 1, wherein the valve control provides a holding current to the solenoid coil when the valve member reaches the second functional position to hold the valve member in the second functional position until a second movement signal arrives, which is directed towards a transfer of the valve member from the second functional position into the first functional position.

5. The solenoid valve according to claim 1, wherein the first electrical energy quantity and the second electrical energy quantity differ from one another by at least one variable from the group: coil voltage, coil current, provision time.

6. The solenoid valve according to claim 1, wherein the valve control detects a coil current through the solenoid coil and uses the detected coil current to determine whether the valve member is in the first functional position or in the second functional position.

7. A method for operating a solenoid valve, for moving a valve member of the solenoid valve between a first functional position and a second functional position by a magnetic field of a solenoid coil, which solenoid coil receives a coil current from a valve control as a function of a movement signal, comprising the following steps: Provision of a first movement signal to the valve control to transfer the valve member from the first functional position to the second functional position, provision of a second movement signal to the valve control in order to transfer the valve member from the second functional position to the first functional position, wherein a terminer determines a period of time which begins when the valve member arrives in the first functional position or when the second movement signal is provided to the valve control, and wherein for a subsequent transfer of the valve member from the first functional position to the second functional position, a quantity of electrical energy is supplied to the solenoid coil by the valve control, which quantity of electrical energy depends on the determined period of time and lies within a predetermined energy interval.

8. The method according to claim 7, wherein the valve control provides a first electrical energy quantity to the solenoid coil when a further first movement signal is provided to the valve control within a predetermined maximum value for the time interval, and wherein the valve control provides a second electrical energy quantity to the solenoid coil, when a further first movement signal is provided to the valve control outside the predetermined maximum value for the time span, wherein the first amount of electrical energy is smaller than the second amount of electrical energy.

9. The method according to claim 7, wherein the valve control detects a coil current through the magnet coil and uses the detected coil current to determine an arrival of the valve member in the first and/or in the second functional position.

10. The method according to claim 7, wherein the valve control provides a holding current to the solenoid coil when the valve member reaches the second functional position and wherein the valve control provides the holding current to the solenoid coil until the second movement signal arrives, which is directed towards a transfer of the valve member from the second functional position into the first functional position.
